(19) United States
(12) Patent Application Publication
(10) Pub. No.: US 2013/0135989 A1
(43) Pub. Date: May 30, 2013

(54) DATA FORWARDING APPARATUS WITH REDUNDANCY

(71) Applicant: HANGZHOU H3C TECHNOLOGIES CO., LTD., Zhejiang (CN)

(72) Inventor: Yantao Zheng, Beijing (CN)

(73) Assignee: HANGZHOU H3C TECHNOLOGIES CO., LTD., Zhejiang (CN)

(21) Appl. No.: 13/683,797

(22) Filed: Nov. 21, 2012

(30) Foreign Application Priority Data
Nov. 24, 2011 (CN) 201110377827.0

(51) Int. Cl. H04L 12/24

(52) U.S. Cl. CPC H04L 41/0654
USPC 370/219

(57) ABSTRACT

A default data forwarding apparatus according to an example may transmit network device access information to a backup apparatus while operating in the normal operation state to facilitate network access to network devices via a backup apparatus when the data forwarding apparatus fails. The backup apparatus may receive and store network device access information for accessing the plurality of network devices while in the backup state to prepare for taking over as a default gateway upon failure of the default data forwarding apparatus.

### FIELD

The disclosure relates to data forwarding apparatus, and more particularly to data forwarding apparatus with redundancy support.

### BACKGROUND

Data forwarding apparatus such as hubs, routers and switches are commonly used in computer networks to provide data connection between devices such that data from a source can be forwarded to a destination. For example, a data forwarding apparatus can be connected between two LANS or WANs, or a LAN and its ISP network. As a data forwarding apparatus is frequently located at a gateway between networks, it is important to ensure continuity of service when apparatus failure occurs. One of the ways to promote service continuity is by means of redundancy using backup.

For example, RFC 3768 has described a virtual router redundancy protocol (VRRP) to provide continuity of data forwarding service by means of a backup data forwarding apparatus when failure occurs at a master data forwarding apparatus.

### DESCRIPTION OF FIGURES

The disclosure will be described by way of non-limiting example with reference to the accompanying Figures, in which:—

FIG. 1 depicts a network comprising a plurality of host computers connected to Internet via data forwarding apparatus with redundancy provisions,

FIG. 2 depicts example operation of the data forwarding apparatus of FIG. 1 during normal operation conditions,

FIG. 3 schematically depicts requests by Router 2 to Router 1 for additional network access information, and

FIG. 4 depicts schematically switch-over operation of the backup data forwarding apparatus of FIG. 1 when one primary router has failed.

### DESCRIPTION OF EXAMPLES

In general, there is described a method of providing backup to a default data forwarding apparatus which operates as a default gateway to access a plurality of network devices in a network, the method comprising:
the default data forwarding apparatus transmitting network device access information to a backup apparatus while operating in the normal operation state to facilitate network access to the plurality of network devices via the backup apparatus when the data forwarding apparatus fails; and
the backup apparatus receiving and storing network device access information required for accessing the plurality of network devices while in the backup state to prepare for taking over as a default gateway upon failure of the default data forwarding apparatus.

Receipt and storing of such network device access information network by the backup apparatus when the default data forwarding apparatus is operating under normal conditions means expeditious switch-over of the backup device to operate as the default gateway can be performed expeditiously when the default data forwarding apparatus fails. As there is no need to collect the network device access information at the time of switch-over, network performance will not be adversely influenced due to flooding of ARP requests as is the case in known switch-over procedures.

The access information may be transmitted using VRRP compatible protocols such as ARP (Address Resolution Protocol) announcements or requests. ARP is defined by RFC826 and is an useful example because it provides resolution of network layer addresses into link layer addresses.

In one aspect, there is provided a data forwarding apparatus for forwarding data to a plurality of network devices in a network when operational in a master state, the apparatus being switchable from a backup state to operational in the master state; wherein the apparatus in the master state operates as a default gateway for the plurality of the network devices, and the apparatus is to receive and store network device access information required for accessing the plurality of network devices while in the backup state.

In an implementation example, the apparatus is a virtual backup router of a router comprising a virtual master router and a virtual backup router, wherein the virtual backup router has a second virtual router identifier (VRID) and the virtual master router has a first VRID and operates as a default gateway for another plurality of network devices when the virtual backup router is in the backup state.

In another aspect, there is provided a data forwarding apparatus for forwarding data to a plurality of network devices in a network as a default gateway, wherein the apparatus is to transmit network device access information to a backup apparatus while operating in the normal operation state to facilitate network access to the plurality of network devices via the backup apparatus when the data forwarding apparatus fails.

In an implementation example, the data forwarding apparatus is a virtual master router of a router comprising a virtual master router and a virtual backup router, wherein the virtual master router has a first VRID to operate as a default gateway for the plurality of network devices, and the virtual backup router has a second VRID to operate as a default gateway for another plurality of network devices, the plurality of network devices and the another plurality of network devices being non overlapping.

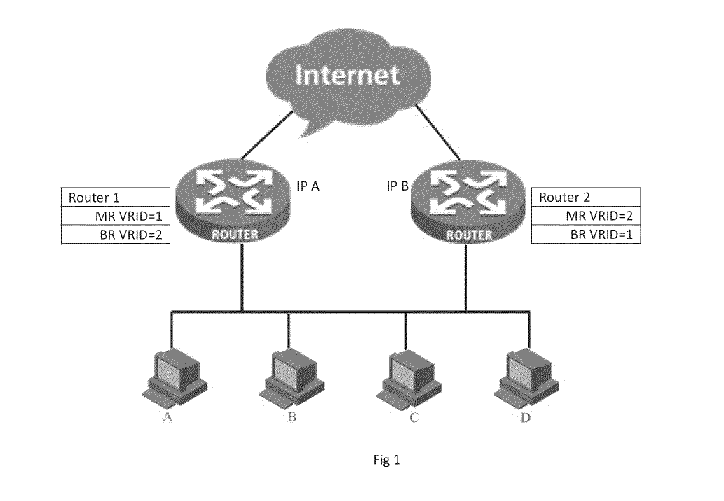

Example implementation of the present disclosure will be described by way of reference to an example network depicted in FIGS. 1 to 4 comprising the implementation examples.

The network of FIGS. 1 to 4 comprises a network of host computers which is connected to the Internet via a first router and a second router. Each of the host computers A, B, C, D, as an example of a network device, has an individual device IP address and the IP addresses for host computers A, B, C, D are IP_HA, IP_HB, IP_HC and IP-HD respectively. The first router is designated for computers A and B, and the second router is designated for computers C and D. On the other hand, the first router includes a backup routing portion which is designated as a backup router for computers C and D in case of failure of the first router, and the second router includes a backup routing portion which is designated as a backup router for computers A and B in case of failure of the second router. In other words, the first and the second routers collective form a group of reciprocally redundant routers for the network.

Specifically, the first router and the backup portion of the second router have the same IP address IP_A. The second router and the backup routing portion of the first router have the same IP address IP_B. There is no competition or conflict between the first router and its backup routing portion in the second routing portion and vice versa because the backup routing portions will not be operational as a router until the primary router fails. When the primary router is in operation, appropriate device access information, such as its IP address and/or MAC address where appropriate, is sent to its counterpart backup routing portion so that the counterpart backup routing portion can transition into routing operation in place of the primary router as soon as failure occurs and is detected. The backup routing portion will store the relevant information for subsequent use. When one of the primary routers (that is, the first router or the second router) fails, all traffic between the host computers A, B, C, D and the external network will pass through the remaining router. The remaining router will then operate as a primary router and as a Backup Router.

Operation of the first router and the second router will be described with reference to the virtual routing redundancy protocol (VRRP) as a convenient example, and the entirety of RFC 3768 on VRRP is incorporated herein by reference.

Referring to FIG. 1, the first and second routers are configured to operate as virtual routers using VRRP. More particularly, the first router, or router 1, is a VRRP router configured as a Master Router having VRID=1 and IP address IP_A for host computers A and B, and as a Backup Router with VRID=2 and IP address IP_B for host computers C and D. The second router, or router 2, is configured as the Master Router having VRID=2 and IP address IP_B for host computers C and D, and as a Backup Router with VRID=1 and IP address IP_A for host computers A and B.

In general, a Master Router is assigned a Priority value of 255 and owns the IP address or IP addresses associated with the virtual router. On initialization, the Master Router will perform the following:
Send an ADVERTISEMENT.
Broadcast a gratuitous ARP request containing the virtual router MAC address for each IP address associated with the virtual router.
Set the Adver_Timer to Advertisement_Interval
Transition to the {Master} state

The Advertisement_Interval above is the time interval between ADVERISEMENTS and the default is 1 second in RFC 3768.

Address Resolution Protocol (ARP) is a telecommunication protocol defined by RFC 826 the entirety of which is incorporated herein by reference. This protocol is used for resolution of network layer addresses into link layer addresses, a critical function in multiple-access networks. ARP is for mapping an Internet Protocol address (IP address) to a physical machine address that is recognized in the local network. The physical machine address is also known as a Media Access Control or MAC address. A table, usually called the ARP cache, is used to maintain a correlation between each MAC address and its corresponding IP address. ARP provides the protocol rules for making this correlation and providing address conversion in both directions.

After initialization, the Master Router periodically sends a message (e.g. a VRPP advertisement message) to the network in order to notify the available state of the Master Router. If the Backup Router does not receive the message due to an error occurring in the Master Router, the Backup Router will draw the conclusion that the Master router is faulty, and the Backup Router will initialize to play the role of the Master Router. In RFC 3768, the Master_Down_Interval is set as the time interval for the Backup Router to declare that the Master Router is down, and the default is set to be (3*Advertisement_Interval+Skew time) where Skew time is the time to skew Master_Down_Interval in seconds, calculated as ((256-Priority)/256). For instance, if the Backup Router does not receive the broadcast message from the Master Router until three transmission periods have elapsed, the Backup Router will initialize to operate as the Master Router.

Under a conventional implementation of RFC3768, the Backup Router does not learn the ARP (IP-to-MAC address) mappings, and massive ARP learning by the Backup Router will take place after the Master Router is declared faulty. As a result, a lot of transient ARP messages will appear on the network and this will have an adverse influence on network performance. On the other hand, virtual routers of the present example are configured to learn the device access information of all the network devices connected to the Master Router from ARP messages when the Master Router is operational (or when the Backup Router is not yet initialized). Specifically, the device access information will include IP address and MAC address of a network device. In some examples, the device information may also include IP address and MAC address mappings, and/or VLAN information.

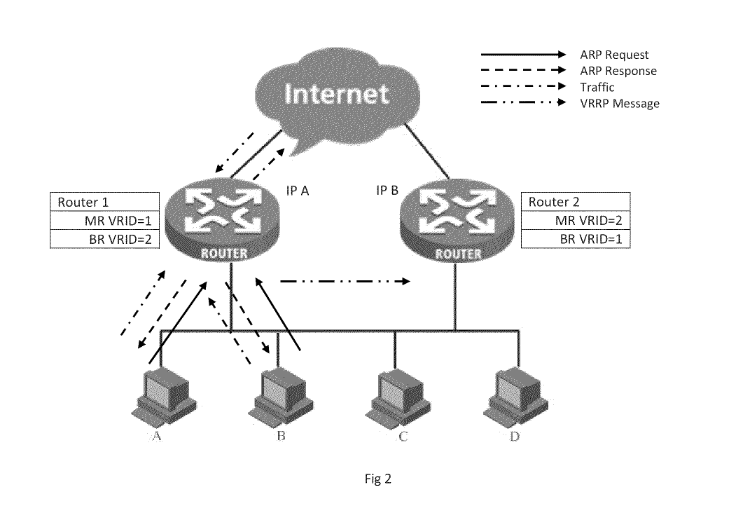

Referring to FIG. 2, when the network devices A and B require Internet access, the network devices A and B will send ARP requests to the Internet gateway, which is a VRRP Virtual IP in this example, to seek the device access information of the current Master Router. In response to the ARP requests, the Master Router, which is Router 1 in this example, will send a ARP response to the network devices A and B and then learn and store the device access information of network devices A and B. The device access information is embedded in the ARP requests previously sent by A and B. After that, the Master Router will send (by broadcast or otherwise) the device access information, including IP address and VLAN information, to the Backup Router (which is Router 2 in this example) by means of VRRP message. An example VRRP packet suitable for carrying such information is as below:

| | | | | |
|---|---|---|---|---|
| Version | Type | Virtual Rtr ID | Priority | IP count |

| | | |
|---|---|---|
| Auth Type | Adver Int | Checksum |

| Virtual IP Address(1) | | |
|---|---|---|
| Virtual IP Address(. . .) | | |
| Virtual IP Address(n) | | |
| ARP1: IP | | |
| ARP1: Vlan | ARP1: Reserved | |
| . . . | | |
| . . . | . . . | |
| ARPn: IP | | |
| ARPn:Vlan | | ARPn:Reserved |

In another example, MAC addresses of the network devices may also be included in the VRRP packet.

In the above VRRP packet example, the ARP information of n network devices is included. The IP address field is usually 32 bit long, the MAC address is usually 48 bit long and the VLAN filed is usually 16 bit long.

As the Master Router for each virtual router will send periodic VRRP Advertisement messages to announce its available state, the device access information can be sent with an Advertisement message.

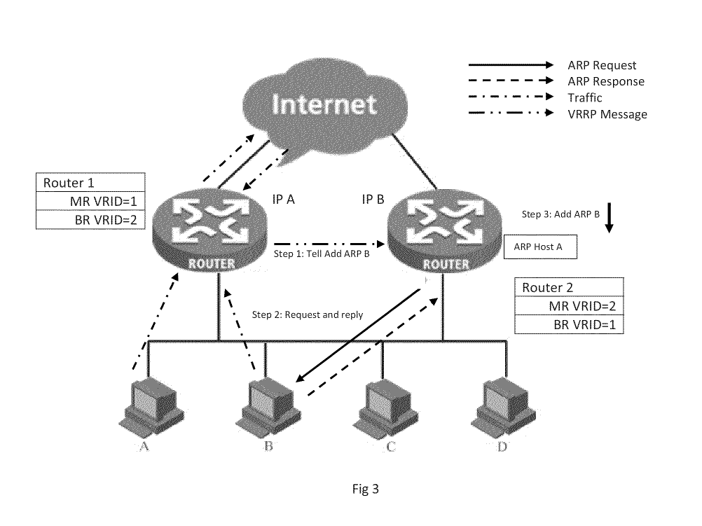

The processor of Router 2 will then learn and store the device access information for use by the backup routing portion of Router 2 when the Router 1 is declared faulty. Where the device access information received by Router 2 is not complete or doubtful, as depicted in FIG. 3, Router 2 will send an ARP request in order to learn the device access information, since an ARP reply containing the device access information will be broadcast on the network in response. The device access information obtained by way of ARP request will then be stored in both the Master and the Backup Router for use.

When there is a material change in ARP information, the Master Router will send an ARP request to obtain updated device access information. The updated device access information obtained by way of ARP request will then be stored in both the Master and the Backup Router for use.

Router 2 operates in essentially the same fashion as Router 1 and so the above description applies mutatis mutandis to Router 2 without loss of generality.

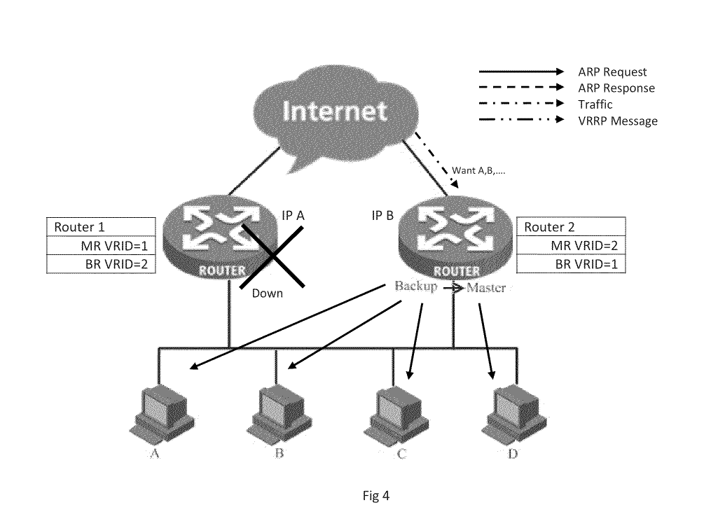

As depicted in FIG. 4, the backup routing portion of Router 2 will operate as a default router in the capacity of a Backup Router with VRID=1 and IP address=IP_A in addition to its original capacity of a Master Router having VRID=2 and IP address=IP_B when Router 1 fails. As Router 2 is already in possession of the device access information of the network devices associated with IP address=IP_A by the time Router 1 fails, there is no need for Router 2 to learn the device access information at the transition time.

Likewise, the backup routing portion of Router 1 will operate as a Backup Router with VRID=2 and IP address=IP_B in addition to its original capacity of a Master Router having VRID=1 and IP address=IP_A when Router 1 fails.

While the example routers, namely Routers 1 and 2, are VRRP virtual routers, it should be appreciated that VRRP routers are only used as a convenient example. For example, Router 1 and Router 2 may be non-virtual routers such that Router 1 is the sole default router for all the host computers while Router 2 is solely a backup router. Alternatively, the routers may be a combination of virtual and non-virtual routers. For example, Router 1 can be a non-virtual router for host computers A to C while Router 2 can be a virtual router configured to operate as a virtual master router for host computer D and a virtual backup master for host computers A to C.

1. A data forwarding apparatus for forwarding data to a plurality of network devices in a network when operational in a master state, the apparatus being switchable from a backup state to operational in the master state; wherein the apparatus in the master state operates as a default gateway for the plurality of the network devices, and the apparatus is to receive and store network device access information required for accessing the plurality of network devices while in the backup state.

2. A data forwarding apparatus according to claim 1, wherein the apparatus is a virtual backup router of a router comprising a virtual master router and a virtual backup router, wherein the virtual backup router has a second virtual router identifier (VRID) and the virtual master router has a first VRID and operates as a default gateway for another plurality of network devices when the virtual backup router is in the backup state.

3. A data forwarding apparatus according to claim 2, wherein the virtual master router and the virtual backup router are VRRP (Virtual Router Redundancy Protocol) compatible.

4. A data forwarding apparatus according to claim 2, wherein the network device access information is transmitted by a broadcast message comprising the IP addresses of the network devices.

5. A data forwarding apparatus according to claim 4, wherein the broadcast message comprises VLAN information of the network devices.

6. A network forwarding apparatus according to claim 4, wherein the broadcast message comprises MAC information of the network devices.

7. A data forwarding apparatus according to claim 4, wherein the broadcast message comprises a VRRP packet comprising an IP header and the IP addresses of the network devices.

8. A data forwarding apparatus according to claim 4, wherein the broadcast message comprises an ARP (address resolution protocol) compatible message.

9. A method of providing backup to a default data forwarding apparatus which operates as a default gateway to access a plurality of network devices in a network, the method comprising:
the default data forwarding apparatus transmitting network device access information to a backup apparatus while operating in the normal operation state to facilitate network access to the plurality of network devices via the backup apparatus when the data forwarding apparatus fails; and
the backup apparatus receiving and storing network device access information required for accessing the plurality of network devices while in the backup state to prepare for taking over as a default gateway upon failure of the default data forwarding apparatus.

10. A method according to claim 9, wherein the method comprises transmitting the network access information by VRRP compatible messages.

11. A data forwarding apparatus for forwarding data to a plurality of network devices in a network as a default gateway, wherein the apparatus is to transmit network device access information to a backup apparatus while operating in the normal operation state to facilitate network access to the plurality of network devices via the backup apparatus when the data forwarding apparatus fails.

12. A data forwarding apparatus according to claim 11, wherein the data forwarding apparatus is a virtual master router of a router comprising the virtual master router and a virtual backup router, wherein the virtual master router has a first VRID to operate as a default gateway for the plurality of network devices, and the virtual backup router has a second VRID to operate as a default gateway for another plurality of network devices, the plurality of network devices and the another plurality of network devices being non overlapping.

13. A data forwarding apparatus according to claim 12, wherein the virtual master router and the virtual backup router are VRRP (Virtual Router Redundancy Protocol) compatible.

14. A data forwarding apparatus according to claim 12, wherein the network device access information is transmitted by a broadcast message comprising the IP addresses of the network devices.

15. A data forwarding apparatus according to claim 14, wherein the broadcast message comprises VLAN information of the network devices.

16. A network forwarding apparatus according to claim 14, wherein the broadcast message comprises MAC information of the network devices.

17. A data forwarding apparatus according to claim 14, wherein the broadcast message comprises a VRRP packet comprising an IP header and the IP addresses of the network devices.

18. A data forwarding apparatus according to claim 14, wherein the broadcast message comprises an ARP (address resolution protocol) compatible message.

19. A data forwarding apparatus according to claim 14, wherein the apparatus is to transmit the broadcast message periodically and when changes in network access information in relation to the plurality of the network devices occur.

20. A data forwarding apparatus according to claim 14, wherein the apparatus is to transmit the broadcast message by a VRRP compatible advertisement.
